(19) United States
(12) Patent Application Publication
(10) Pub. No.: US 2023/0063874 A1
(43) Pub. Date: Mar. 2, 2023

(54) Garage Floor Protector Assembly

(71) Applicant: Shannon Olson, Andover, MN (US)

(72) Inventor: Shannon Olson, Andover, MN (US)

(21) Appl. No.: 17/464,782

(22) Filed: Sep. 2, 2021

(51) Int. Cl. E04H 6/42; F16N 31/00

(52) U.S. Cl. CPC E04H 6/428; F16N 31/006

(57) ABSTRACT

A garage floor protector assembly for inhibiting a floor of a garage from getting dirty includes a pan that is positionable on a floor of a garage. The pan has dimensions sufficient to accommodate a passenger vehicle to facilitate the passenger vehicle to park on the pan. The pan is comprised of a fluid impermeable material to inhibit dirt and fluid on the passenger vehicle from collecting on the floor of the garage. A plurality of poles is each insertable into a respective one of the marker points to facilitate a visual reference for a driver of the passenger vehicle that is parking on the pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to floor protector devices and more particularly pertains to a new floor protector device for inhibiting a floor of a garage from getting dirty. The device includes a pan upon which a passenger vehicle can be parked and a plurality of poles that are each insertable into the pan. The poles are vertically oriented and strategically positioned to facilitate a visual reference for a driver to accurately park the passenger vehicle on the pan.

### (2) Description of Related Art Including Information Disclosed Under 37 CFR 1.97 and 1.98

The prior art relates to floor protector devices including a variety of floor pans that are positionable on a garage floor and which have a raised ridge extending around a perimeter of the floor pans. The prior art discloses a vehicle drip mat which includes sloped ramps on either end of the vehicle grip mat and a pair of guide poles that extend upwardly from the vehicle grip mat. The prior art discloses a garage floor mat for absorbing oil from a vehicle and which has a stop sign extending upwardly from the garage floor mat. The prior art discloses a motorcycle parking pad for collecting oil that drips from a motorcycle and a pair of holders for retaining a motorcycle in an aesthetically pleasing position.

### BRIEF SUMMARY OF THE INVENTION

An embodiment of the disclosure meets the needs presented above by generally comprising a pan that is positionable on a floor of a garage. The pan has dimensions sufficient to accommodate a passenger vehicle to facilitate the passenger vehicle to park on the pan. The pan is comprised of a fluid impermeable material to inhibit dirt and fluid on the passenger vehicle from collecting on the floor of the garage. A plurality of poles is each insertable into a respective one of the marker points to facilitate a visual reference for a driver of the passenger vehicle that is parking on the pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a garage floor protector assembly according to an embodiment of the disclosure.

FIG. 2 is a front view of an embodiment of the disclosure.

FIG. 3 is a back view of an embodiment of the disclosure.

FIG. 4 is a perspective in-use view of an embodiment of the disclosure.

FIG. 5 is a top in-use view of an embodiment of the disclosure.

### DETAILED DESCRIPTION OF THE INVENTION

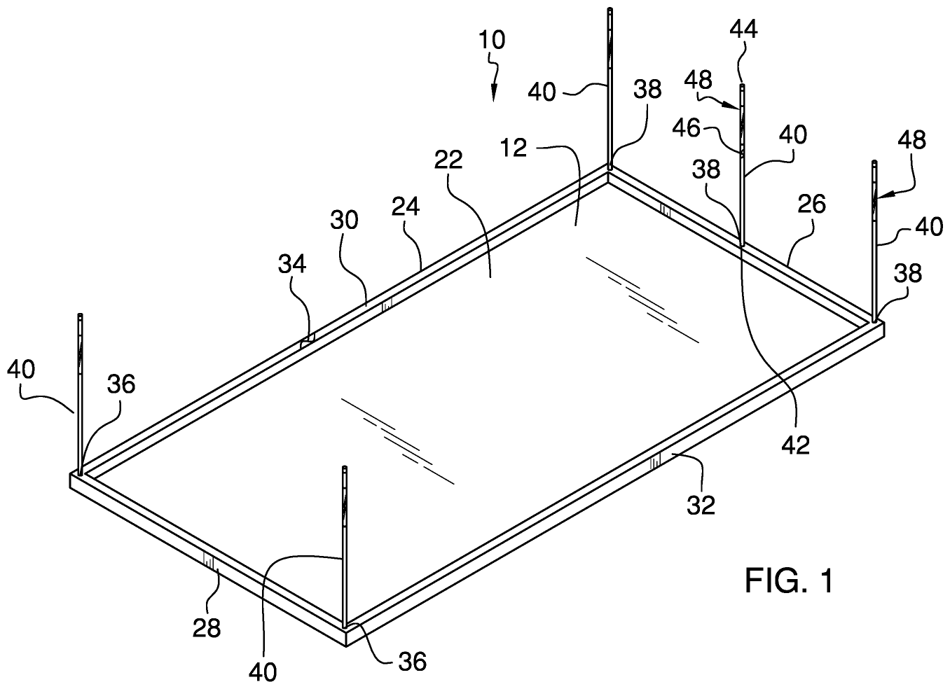

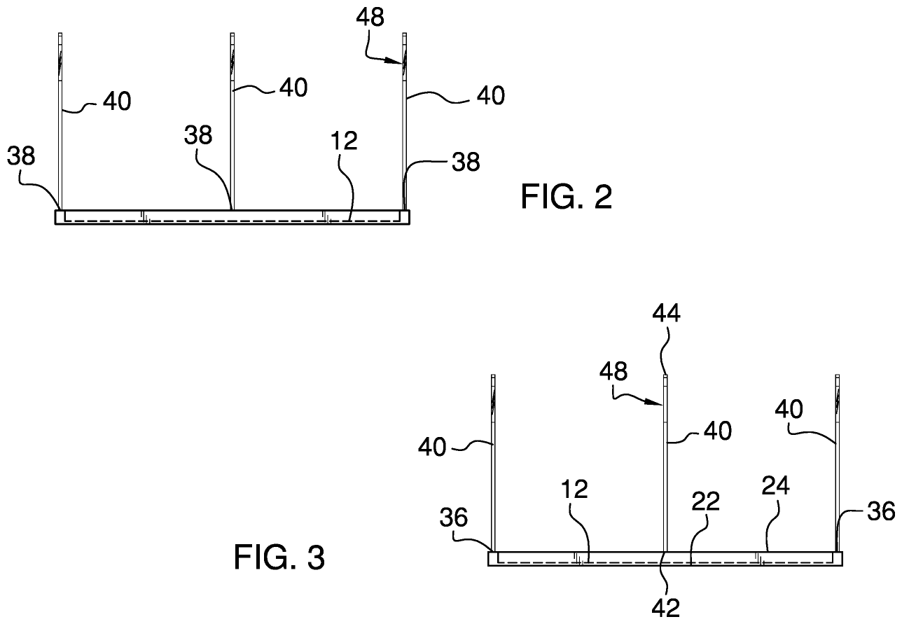

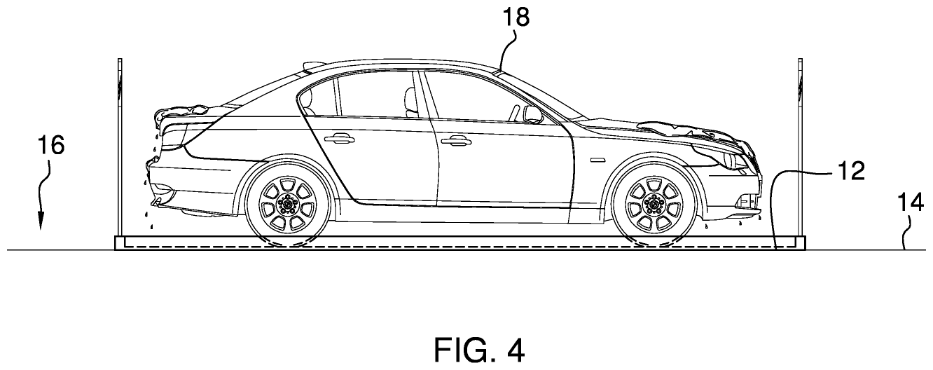

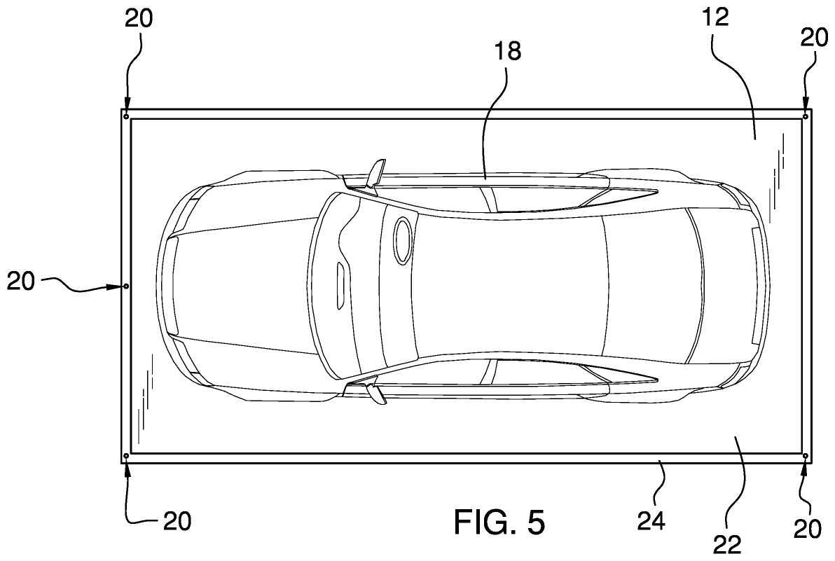

With reference now to the drawings, and in particular to FIGS. 1 through 5 thereof, a new floor protector device embodying the principles and concepts of an embodiment of the disclosure and generally designated by the reference numeral 10 will be described.

As best illustrated in FIGS. 1 through 5, the garage floor protector assembly 10 generally comprises a pan 12 that is positionable on a floor 14 of a garage 16. The pan 12 has dimensions sufficient to accommodate a passenger vehicle 18 to facilitate the passenger vehicle 18 to park on the pan 12. The passenger vehicle 18 may be any motorized vehicle that is driven on public roadways and the garage 16 may be a garage in which the passenger vehicle 18 is parked. The pan 12 is comprised of a fluid 19 impermeable material to inhibit dirt and fluid 19 on the passenger vehicle 18 from collecting on the floor 14 of the garage 16. Additionally, the pan 12 has a plurality of maker points 20 that is each integrated into the pan 12.

The pan 12 has a basal wall 22 and a lip 24 extending upwardly from the basal wall 22. The lip 24 is coextensive with a perimeter of the basal wall 22 to inhibit the dirt and fluid 19 from spilling outwardly from the pan 12. In this way the pan 12 inhibits the floor 14 of the garage 16 from getting covered with the dirt and fluid 19. The lip 24 has a front side 26, a back side 28, a first lateral side 30, a second lateral side 32 and a distal surface 34 with respect to the basal wall 22. The distal surface 34 has a plurality of rear wells 36 each extending downwardly toward the basal wall 22.

Each of the rear wells 36 is aligned with a respective one of an intersection between the first lateral side 30 and back side 28 and an intersection between the second lateral side 32 and the back side 28. The distal surface 34 has a plurality of front wells 38 each extending downwardly toward the basal wall 22. The plurality of front wells 38 are spaced apart from each other and are distributed along a full length of the front side 26 of the lip 24. Furthermore, each of the front wells 38 and each of the rear wells 36 define a respective one of the marker points 20.

A plurality of poles 40 is provided and each of the poles 40 is insertable into a respective one of the marker points 20 having each of the poles 40 being vertically oriented. In this way the plurality of poles 40 facilitate a visual reference for a driver of the passenger vehicle 18 that is parking on the pan 12. Each of the poles 40 has a bottom end 42 and a top end 44, and the bottom end 42 of each of the poles 40 is insertable into a respective one of the front wells 38 or a respective one of the rear wells 36. An outer surface 46 of each of the poles 40 has a reflective portion 48 which extends substantially between the top end 44 and the bottom end 42. The reflective portion 48 of the outer surface 46 of each of the poles 40 is comprised of a light reflecting material to reflect light for enhancing visibility of the poles 40 for the driver. Additionally, the reflective portion 48 on the outer surface 46 of each of the poles 40 is positioned closer to the top end 44 than the bottom end 42. In this way the reflective portion 48 is elevated over the passenger vehicle 18 to facilitate the reflective portion 48 to be visible to the driver.

In use, the pan 12 is positioned on the floor 14 of the garage 16 and each of the poles 40 is inserted into the respective front wells 38 or rear wells 36. The passenger vehicle 18 is driven onto the pan 12 when the passenger vehicle 18 is parked in the garage 16. In this way the pan 12 collects dirt and fluid 19 which fall from the passenger vehicle 18. Thus, the dirt and fluid 19 do not collect on the floor 14 of the garage 16 thereby keeping the floor 14 of the garage 16 clean. Additionally, the poles 40 assist the driver with positioning the passenger vehicle 18 on the pan 12 when the driver is parking the passenger vehicle 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A garage floor protector assembly for inhibiting dirt and fluids dropped from a vehicle from collecting on a garage floor, said assembly comprising:
a pan being positionable on a floor of a garage, said pan having a basal wall and a lip extending upwardly from said basal wall, said lip being coextensive with a perimeter of said basal wall, said basal wall and said lip cooperatively defining a single continuous cavity, said single continuous cavity being positioned entirely above a top surface of said basal wall, said pan having dimensions being sufficient to accommodate a passenger vehicle wherein said pan is configured to facilitate the passenger vehicle to park on said pan, said pan being comprised of a fluid impermeable material wherein said pan is configured to inhibit dirt and fluid on the passenger vehicle from collecting on the floor of the garage, wherein said lip is configured to inhibit the dirt and fluid from spilling outwardly from said pan, said pan having a plurality of marker points each being integrated into said pan; and
a plurality of poles, each of said poles being insertable into a respective one of said marker points having each of said poles being vertically oriented wherein said plurality of poles is configured to facilitate a visual reference for a driver of the passenger vehicle that is parking on said pad.

2. The assembly according to claim 1, wherein said lip has a front side, a back side, a first lateral side, a second lateral side and a distal surface with respect to said basal wall, said distal surface having a plurality of rear wells each extending downwardly toward said basal wall, said distal surface having a plurality of front wells each extending downwardly toward said basal wall.

3. The assembly according to claim 2, wherein each of said rear wells is aligned with a respective one of an intersection between said first lateral side and back side and an intersection between said second lateral side and said back side, said plurality of front wells being spaced apart from each other and being distributed along a full length of said front side of said lip, each of said front wells and each of said rear wells defining a respective one of said marker points.

4. The assembly according to claim 2, wherein each of said poles has a bottom end and a top end, said bottom end of each of said poles being insertable into a respective one of said front wells or a respective one of said rear wells.

5. The assembly according to claim 4, wherein an outer surface of each of said poles has a reflective portion extending between said top end and said bottom end, said reflective portion of said outer surface of each of said poles being comprised of a light reflecting material wherein said reflective portion is configured to reflect light to enhance visibility of said poles for the driver.

6. The assembly according to claim 4, wherein an outer surface of each of said poles has a reflective portion being positioned between said top end and said bottom end, said reflective portion of said outer surface of each of said poles being comprised of a light reflecting material wherein said reflective portion is configured to reflect light to enhance visibility of said poles for the driver, said reflective portion on said outer surface of each of said poles being positioned closer to said top end than said bottom end wherein said reflective portion is configured to be elevated over the passenger vehicle to facilitate said reflective portion to be visible to the driver.

7. A garage floor protector assembly for inhibiting dirt and fluids dropped from a vehicle from collecting on a garage floor, said assembly comprising:
a pan being positionable on a floor of a garage, said pan having dimensions being sufficient to accommodate a passenger vehicle wherein said pan is configured to facilitate the passenger vehicle to park on said pan, said pan being comprised of a fluid impermeable material wherein said pan is configured to inhibit dirt and fluid on the passenger vehicle from collecting on the floor of the garage, said pan having a plurality of marker points each being integrated into said pan, said pan having a basal wall and a lip extending upwardly from said basal wall, said lip being coextensive with a perimeter of said basal wall, said basal wall and said lip cooperatively defining a single continuous cavity, said single continuous cavity being positioned entirely above a top surface of said basal wall, wherein said lip is configured to inhibit the dirt and fluid from spilling outwardly from said pan, said lip having a front side, a back side, a first lateral side, a second lateral side and a distal surface with respect to said basal wall, said distal surface having a plurality of rear wells each extending downwardly toward said basal wall, each of said rear wells being aligned with a respective one of an intersection between said first lateral side and back side and an intersection between said second lateral side and said back side, said distal surface having a plurality of front wells each extending downwardly toward said basal wall, said plurality of front wells being spaced apart from each other and being distributed along a full length of said front side of said lip, each of said front wells and each of said rear wells defining a respective one of said marker points; and
a plurality of poles, each of said poles being insertable into a respective one of said marker points having each of said poles being vertically oriented wherein said plurality of poles is configured to facilitate a visual reference for a driver of the passenger vehicle that is parking on said pad, each of said poles having a bottom end and a top end, said bottom end of each of said poles being insertable into a respective one of said front wells or a respective one of said rear wells.

8. A method of keeping a garage floor clean, the steps of the method comprising:
providing a pan having sufficient dimensions to have a passenger vehicle parked on said pan, said pan having a lip extending upwardly from a perimeter of said pan, said basal wall and said lip cooperatively defining a single continuous cavity, said single continuous cavity being positioned entirely above a top surface of said basal wall, said lip having a plurality of wells each extending downwardly into said lip;
providing a plurality of poles;
positioning said pan on a floor of a garage wherein said pan is configured to collect dirt and fluid from the passenger vehicle; and
inserting each of said poles into a respective one of said wells wherein said poles are configured to facilitate a visual reference for a driver of a passenger vehicle; and
driving the passenger vehicle onto said pan such that said pan collects dirt and debris from the passenger vehicle.

9. The assembly according to claim 7, an outer surface of each of said poles having a reflective portion extending between said top end and said bottom end, said reflective portion of said outer surface of each of said poles being comprised of a light reflecting material wherein said reflective portion is configured to reflect light to enhance visibility of said poles for the driver, wherein said reflective portion is configured to be elevated over the passenger vehicle to facilitate said reflective portion to be visible to the driver.

10. The assembly according to claim 7, an outer surface of each of said poles having a reflective portion being positioned between said top end and said bottom end, said reflective portion of said outer surface of each of said poles being comprised of a light reflecting material wherein said reflective portion is configured to reflect light to enhance visibility of said poles for the driver, said reflective portion on said outer surface of each of said poles being positioned closer to said top end than said bottom end wherein said reflective portion is configured to be elevated over the passenger vehicle to facilitate said reflective portion to be visible to the driver.
